(19) United States
(12) Patent Application Publication
(10) Pub. No.: US 2026/0350524 A1
(43) Pub. Date: Nov. 5, 2026

(54) WORK ANALYZING DEVICE AND WORK ANALYZING METHOD

(71) Applicant: Panasonic Intellectual Property Management Co., Ltd., Osaka (JP)

(72) Inventor: Sonoko HIRASAWA, Kanagawa (JP)

(73) Assignee: Panasonic Intellectual Property Management Co., Ltd., Osaka (JP)

(21) Appl. No.: 19/485,923

(22) PCT Filed: May 20, 2024
(86) PCT No.: PCT/JP2024/018536

§ 371 Date: Nov. 19, 2025

(30) Foreign Application Priority Data
May 22, 2023 (JP) 2023-084029

(51) Int. Cl. G06Q 10/0639; G06V 10/764; G06V 20/52; G06V 40/20

(52) U.S. Cl. CPC G06Q 10/06395; G06V 10/764; G06V 20/52; G06V 40/20

(57) ABSTRACT

Work done by a worker is recognized based on a video in which a working scene of the worker is captured, working quality of the work done by the worker is evaluated based on a working result, and a score mark is displayed as analysis information that visualizes a working state including an evaluation result of the working quality. Further, value-added work and non-value-added work done by the worker are recognized based on the video, and a graph that represents and piles up execution times of the value-added work and the non-value-added work is displayed as the analysis information that distinguishes the value-added work and the non-value-added work.

### TECHNICAL FIELD

The present disclosure relates to a work analyzing device and a work analyzing method that output analysis information about a working state of a worker based on a video in which a working scene of the worker is captured.

### BACKGROUND ART

At the centers of manufacture and logistics, the efficiency of work can be improved by analyzing a working state of a worker and reviewing the way the work is carried out based on the result of the analysis.

As a technique for analyzing such a working state of a worker, there is a known technique to measure a working time for each working item based on a video in which a working scene of the worker is captured, and output a value-added graph in which the working time is set on a horizontal axis and a value-added coefficient for each working item is set on a vertical axis (see Patent Document 1). This technique allows a user to visually identify the work with low added value and the work with long working time from the value-added graph.

### PRIOR ART DOCUMENT(S)

### Patent Document(s)

Patent Document 1: JP2003-6286A

### SUMMARY OF THE INVENTION

### Task to be Accomplished by the Invention

In the conventional technique, the work done by the worker is evaluated while focusing on an added value the work gives to an object (workpiece) as a working target. However, since the level of the added value is predetermined according to working items, the work related to the same working item is evaluated based on the length of time. This leads to a problem that progress in improving the quality of the work and leveling the work becomes insufficient as the speed of the work is made much of.

Accordingly, the main purpose of the present disclosure is to provide a work analyzing device and a work analyzing method that allow a user to examine a working state of a target worker in consideration of the quality of work done by the worker, thereby enabling sufficient progress in improving the quality of the work and leveling the work.

### Means to Accomplish the Task

A work analyzing device of the present disclosure is a work analyzing device comprising a processor configured to execute a process to output analysis information about a working state of a worker based on a video in which a working scene of the worker is captured, wherein the processor is configured to: recognize, based on the video, work done by the worker; evaluate, based on a working result, working quality of the work done by the worker; and generate the analysis information that visualizes the working state including an evaluation result of the working quality.

Further, a work analyzing method of the present disclosure is a work analyzing method that executes, by a processor, a process to output analysis information about a working state of a worker based on a video in which a working scene of the worker is captured, and the work analyzing method comprises: recognizing, based on the video, work done by the worker; evaluating, based on a working result, working quality of the work done by the worker; and generating the analysis information that visualizes the working state including an evaluation result of the working quality.

### Effect of the Invention

According to the present disclosure, by focusing on a working result, that is, a finished state of an object as a working target, it is possible to evaluate the work done by a target worker, visualize a working state including an evaluation result of working quality, and present the working state to a user. This allows the user to examine the working state of the target worker while considering the quality of the work done by the worker, thereby enabling sufficient progress in improving the quality of the work and leveling the work.

### BRIEF DESCRIPTION OF THE DRAWING(S)

FIG. 1 an overall block diagram of a work analyzing system according to the present embodiment

FIG. 2 a block diagram showing a schematic configuration of a server

FIG. 3 a block diagram showing an overview of a process executed by the server

FIG. 4 an explanatory diagram showing how to acquire a time score in a working time evaluation process

FIG. 5 an explanatory diagram showing proposal contents (messages) according to the combination of a quality score and a time score

FIG. 6 a flowchart showing the steps of the process executed by the server

FIG. 7 an explanatory diagram showing a graph screen displayed on a user terminal

FIG. 8 an explanatory diagram showing a state when a display condition setting section on the graph screen is operated

FIG. 9 an explanatory diagram showing another example of the graph screen displayed on the user terminal

FIG. 10 an explanatory diagram showing a timeline screen displayed on the user terminal

FIG. 11 an explanatory diagram showing a video playback screen displayed on the user terminal

### MODE(S) FOR CARRYING OUT THE INVENTION

The first invention made to solve the above problem is configured such that a work analyzing device comprises a processor configured to execute a process to output analysis information about a working state of a worker based on a video in which a working scene of the worker is captured, wherein the processor is configured to: recognize, based on the video, work done by the worker; evaluate, based on a working result, working quality of the work done by the worker; and generate the analysis information that visualizes the working state including an evaluation result of the working quality.

Accordingly, it is possible to evaluate the work done by the target worker, visualize the working state including the evaluation result of the working quality, and present the working state to the user while focusing on a working result, that is, a finished state of an object as a working target. This allows the user to examine the working state of the target worker while considering the quality of the work done by the worker, thereby enabling sufficient progress in improving the quality of the work and leveling the work.

Further, the second invention is configured such that the processor is further configured to: recognize, based on the video, value-added work and non-value-added work done by the worker; and generate the analysis information that distinguishes the value-added work and the non-value-added work.

Accordingly, it is possible for the user to properly understand the working state of the target worker.

Further, the third invention is configured such that the processor is further configured to generate, as the analysis information, a visualization image that represents execution times of the value-added work and the non-value-added work in a stacked manner.

Accordingly, it is possible for the user to check the details of the work done by the target worker. In this case, the visualization image is, for example, a stacked graph. It is also possible to generate the visualization image that represents the execution times of a plurality of working items in a stacked manner.

Further, the fourth invention is configured such that the processor is further configured to generate, as the analysis information, a visualization image that represents execution states of the value-added work and the non-value-added work on a timeline.

Accordingly, it is possible for the user to understand how the target worker proceeds with the work. In this case, the visualization image is, for example, a timeline chart. It is also possible to generate the visualization image that represents the execution state for each of working items on a timeline.

Further, the fifth invention is configured such that the processor is further configured to recognize the work done by the worker through action recognition using a plurality of classifiers configured to determine, based on the video, a class to which a recognition target belongs.

Accordingly, it is possible to accurately recognize the work done by the target worker. In this case, for example, it is possible to identify the working item of the work done by the target worker. Further, for example, it is possible to determine whether the work done by the target worker is the value-added work.

Further, the sixth invention is configured such that the processor is further configured to select a content of a proposal to a user based on an evaluation result of the working quality and a working time of the worker.

Accordingly, it is possible to provide the user with appropriate proposals for improving their working condition.

Further, the seventh invention is configured such that a work analyzing method executes, by a processor, a process to output analysis information about a working state of a worker based on a video in which a working scene of the worker is captured, the work analyzing method comprising: recognizing, based on the video, work done by the worker; evaluating, based on a working result, working quality of the work done by the worker; and generating the analysis information that visualizes the working state including an evaluation result of the working quality.

Accordingly, similar to the first invention, it is possible for the user to examine the working state of the target worker while considering the quality of the work done by the worker, thereby enabling sufficient progress in improving the quality of the work and the leveling the work.

In the following, embodiments of the present disclosure will be described with reference to the drawings.

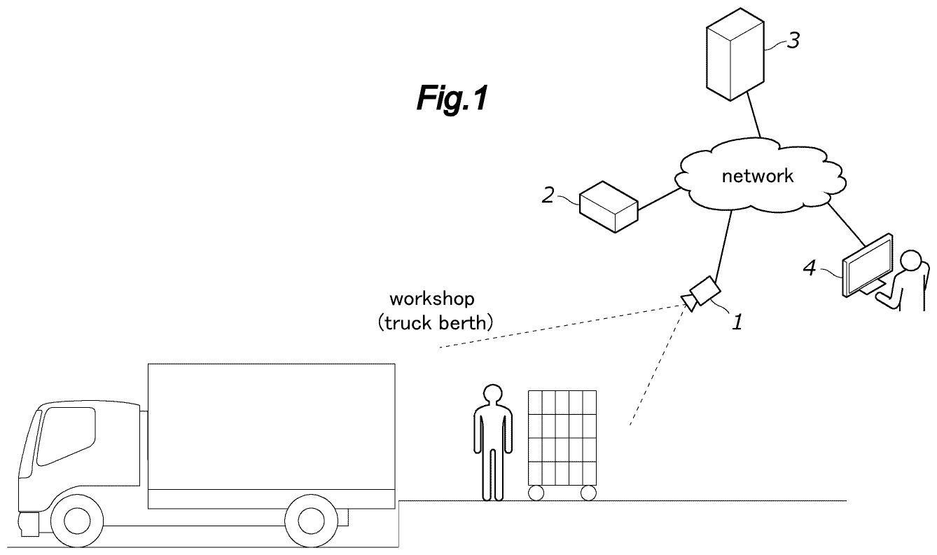

FIG. 1 is an overall block diagram of a work analyzing system according to the present embodiment.

This system analyzes the working state of the worker at centers of manufacture and logistics, and presents the results of the analysis to the manager and the worker. The system includes a plurality of cameras 1, a recorder 2, a server 3 (work analyzing device), and a user terminal 4. The camera 1, the recorder 2, the server 3, and the user terminal 4 are connected via a network.

The camera 1 captures the working scene of the worker in the workshop. The example of FIG. 1 shows a truck berth where the cargos are carried in and out.

The recorder 2 records the video output from the camera 1.

The server 3 acquires the video from the camera 1 or the recorder 2, analyzes the working state of the worker based on the video, and outputs the analysis results thereof.

The user terminal 4 is used by a user such as a work administrator or the worker himself/herself, and consists of a PC, tablet terminal, and the like. The analysis results output from the server 3 are displayed on the user terminal 4, and the user can view the analysis results.

The process executed by the server 3 may be a real-time process executed simultaneously with capturing of the video, or a post-process executed after the capturing of the video. The video captured by the camera 1 is transmitted to the server 3 in a case of the real-time process, and the video stored in the recorder 2 is transmitted to the server 3 in a case of the post-process. In a case of the post-process, the server 3 may directly read the video from various storage media.

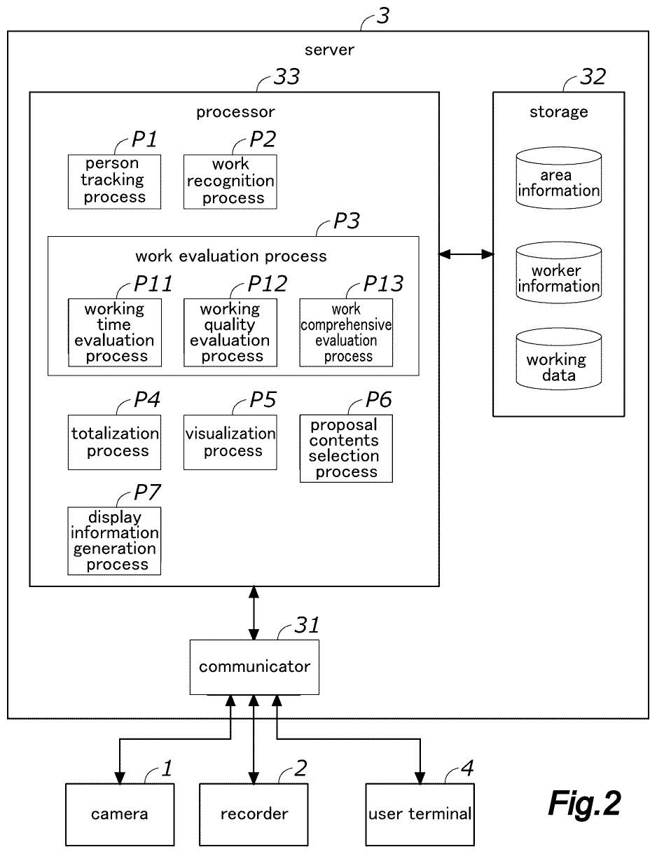

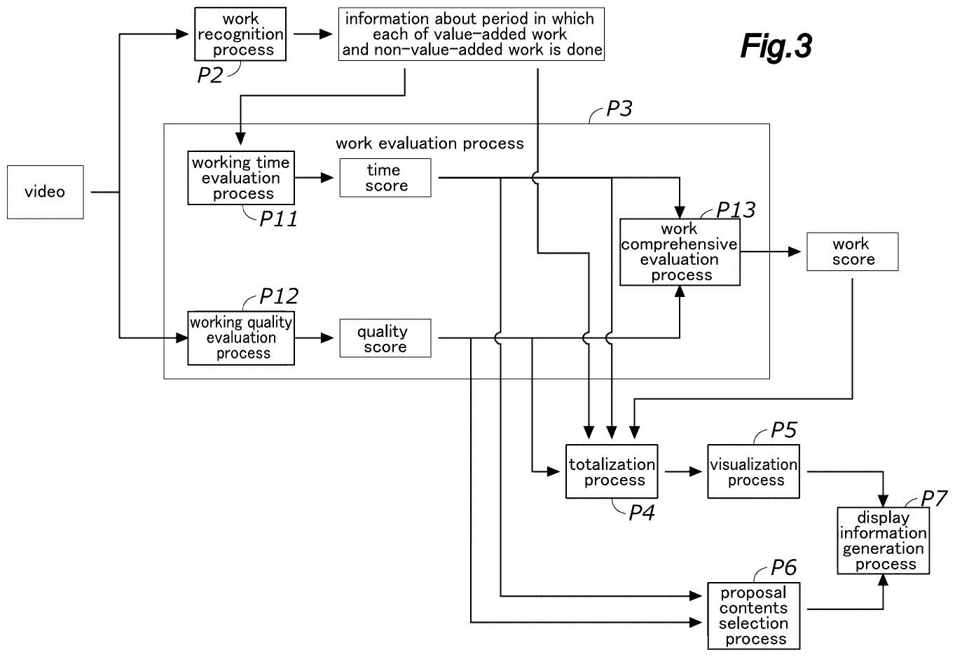

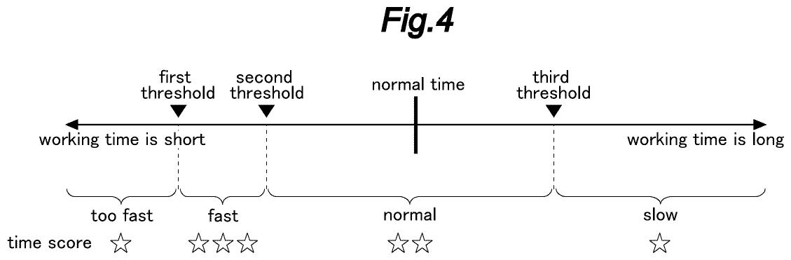

Next, the server 3 will be described. FIG. 2 is a block diagram showing a schematic configuration of the server 3. FIG. 3 is a block diagram showing an overview of the process executed by the server 3. FIG. 4 is an explanatory diagram showing how to acquire a time score in a working time evaluation process P11.

As shown in FIG. 2, the server 3 includes a communicator 31, a storage 32, and a processor 33.

The communicator 31 communicates with the camera 1, the recorder 2, and the user terminal 4.

The storage 32 stores programs executed by the processor 33, and the like. The storage 32 also stores area information about the workshop, worker information about the worker, and working data about the working state of the worker generated by the processor 33.

The processor 33 executes various processes by executing programs stored in the storage 32. In the present embodiment, the processor 33 executes a person tracking process P1, a work recognition process P2, a work evaluation process P3, a totalization process P4, a visualization process P5, a proposal contents selection process P6, and a display information generation process P7.

In the person tracking process P1, the processor 33 tracks the worker doing the work in the workshop based on the video from the camera 1, and generates person tracking information. At this time, a person detecting process is executed to detect the person from the video from the camera 1. Further, when a plurality of cameras 1 is installed, a person re-identification process is executed to associate the person detected from the video of each camera 1 with the same person. The person tracking information acquired based on the person re-identification process includes location information for each person (ID) at each time.

As shown in FIG. 3, in the work recognition process P2, the processor 33 recognizes the work (value-added work and non-value-added work) done by the target worker based on the video from the camera 1. The value-added work and the non-value-added work can be set in advance depending on the work to be analyzed. For example, the scheduled work (that is, the work requested of the worker) is set as the value-added work, and the remaining work is set as the non-value-added work. More specifically, the work of loading the cargo and the work of unloading the cargo, which will be described later, are set as the value-added work. On the other hand, the work other than the value-added work, and the state where the work is suspended before or after the value-added work (for example, a state where the work is waited for), are set as the non-value-added work.

At this time, the action recognition is executed using the person image extracted from the video from the camera 1. More specifically, the action is recognized by the classification using an action recognition engine (machine learning model) constructed by machine learning, that is, the action is recognized using a plurality of classifiers configured to determine a class (work) to which the recognition target (action of the person) belongs. Such an action recognition engine can be trained using prepared training data on the value-added work and the non-value-added work. Accordingly, it is possible to determine whether the recognized work is the value-added work or the non-value-added work based on a plurality of classes (work) to which the recognition target belongs. Further, the work recognition process P2 uses, for example, an interaction recognition technique, that is, a technique for recognizing the behavior of the person by focusing on the interaction between the person and the object.

Further, in the work recognition process P2, the completion of the work is detected when a series of actions recognized as one piece of work are done, and the period in which the one piece of work is done, that is, the period in which each of the value-added work and the non-value-added work is done is identified. Further, if there is a short break between the one piece of work and another, the break for the work may be considered to be included in the execution period of the value-added work, provided that the break is shorter than the prescribed time. In this case, if the break is equal to or greater than the prescribed time, the break for that work is considered to be the non-value-added work.

The work evaluation process P3 includes a working time evaluation process P11, a working quality evaluation process P12, and a work comprehensive evaluation process P13.

In the working time evaluation process P11, the processor 33 evaluates the working time of the target worker by comparing the working time thereof with the normal time that has been set in advance, and acquires the time score. The working time is calculated by adding the execution time of the value-added work and the execution time of the non-value-added work. Further, the normal time is set for each piece of work based on the past working time in the target workshop.

In the present embodiment, the working time is evaluated at three levels, and the time score is determined at three levels (1 to 3). At this time, as shown in FIG. 4, the working time is compared with the first to third thresholds, and then the working time is evaluated. More specifically, if the working time is less than the first threshold, the work is evaluated as being too fast, and the time score is set to “1”. The first threshold may be set as a time value at which even an expert in the work finds it difficult to maintain the normal quality of the work. Further, if the working time is equal to or greater than the first threshold and less than the second threshold, the work is evaluated as being fast, and the time score is set to “3”. Further, if the working time is equal to or greater than the second threshold and less than the third threshold, the work is evaluated as being normal, and the time score is set to “2”. Further, if the working time is equal to or greater than the third threshold, the work is evaluated as slow, and the time score is set to “1”.

As shown in FIG. 3, in the working quality evaluation process P12, the processor 33 determines the finished state of the work (working result), that is, the state of an object as a working target, evaluates the quality of the work done by the worker based on the determination result thereof, and acquires the quality score. The working quality evaluation process P12 is executed every time the end of the work is detected in the work recognition process P2.

At this time, the object as a working target is detected from the video from the camera 1, and object recognition is executed on the image of that object. More specifically, the object is recognized by classification using an object recognition engine (machine learning model) constructed by machine learning, that is, the object is recognized using a plurality of classifiers configured to determine the class (the state of the object according to the working quality) to which the recognition target (the object as a working target) belongs.

For example, in the work of loading the cargo, the condition of the cargo loaded into a roll container is evaluated. More specifically, if the cargo is loaded neatly and fully in the roll container, the quality score will be high; conversely, if the cargo is loaded messily and sparsely, the quality score will be low.

In the present embodiment, the working quality is evaluated at three levels, and the quality score is determined at three levels (1 to 3). If the work is done carefully and the working quality is good, the quality score is set to “3”. If the work is normal and the working quality is normal, the quality score is set to “2”. If the work is sloppy and the working quality is poor, the quality score is set to “1”.

The working quality evaluation process P12 may be executed using the video other than the video used in the work recognition process P2, for example, the video captured by another camera 1, or may be executed using detection data other than the video from a sensor.

In the work comprehensive evaluation process P13, the processor 33 comprehensively evaluates the working state of the target worker based on the time score acquired in the working time evaluation process P11 and the quality score acquired in the working quality evaluation process P12, and acquires the work score. More specifically, the work score is calculated by averaging the time score and the quality score. Further, in addition to simple averaging, a weighted averaging may be used to calculate the work score, and further, a statistical process other than averaging may be used.

In the totalization process P4, the processor 33 totalizes the results of the work recognition process P2, the working time evaluation process P11, the working quality evaluation process P12, and the work comprehensive evaluation process P13 based on the display condition (the workshop, the date and time, and the worker) identified by the user.

More specifically, based on the information (the start time and the end time) about the period in which each of the value-added work and the non-value-added work is done, the working time for each of the value-added work and the non-value-added work in the identified period (for example, the time range) is calculated. In this case, the working times of the work done plural times within the identified period are added up to calculate the working time for the entire identified period.

Further, the score for the entire identified period (for example, the time range) is calculated by averaging the scores (the time score, the quality score, and the work score) for the work done plural times within the identified period.

In the visualization process P5, the processor 33 generates the information that visualizes the working state of the target worker, that is, the execution states of the value-added work and the non-value-added work, based on each of the process results of the work recognition process P2 and the totalization process P4.

More specifically, a graph (visualization image) that represents the execution times of the value-added work and the non-value-added work in a stacked manner is generated. Further, a timeline chart (visualization image) that represents the execution states of the value-added work and the non-value-added work on a timeline is generated. Further, a score mark (visualization image) that represents the evaluation result (the time score, the quality score, and the work score) for the working state of the target worker is generated.

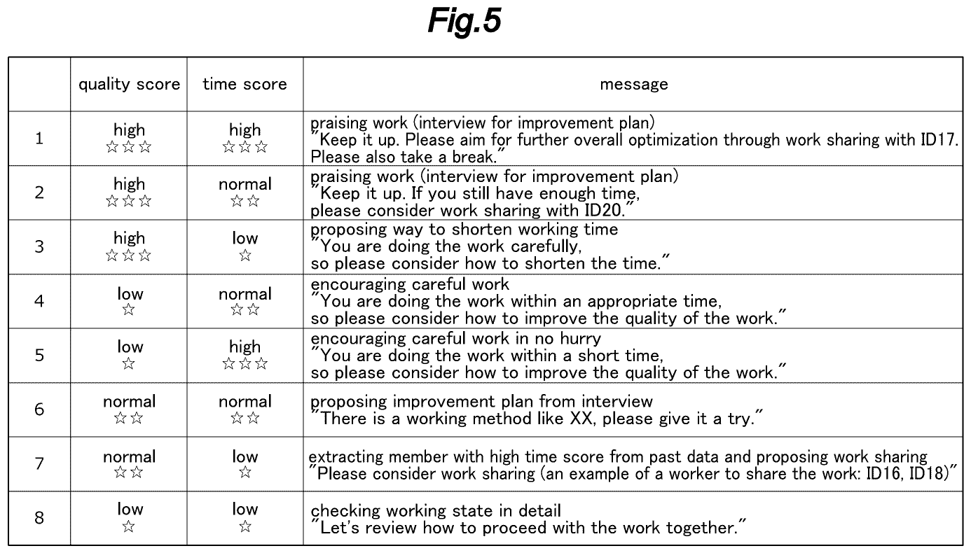

In the proposal contents selection process P6, the processor 33 selects the contents (message) to be proposed to the user for the working improvement based on the evaluation results related to the working quality and the working time, that is, the quality score and the time score (see FIG. 5).

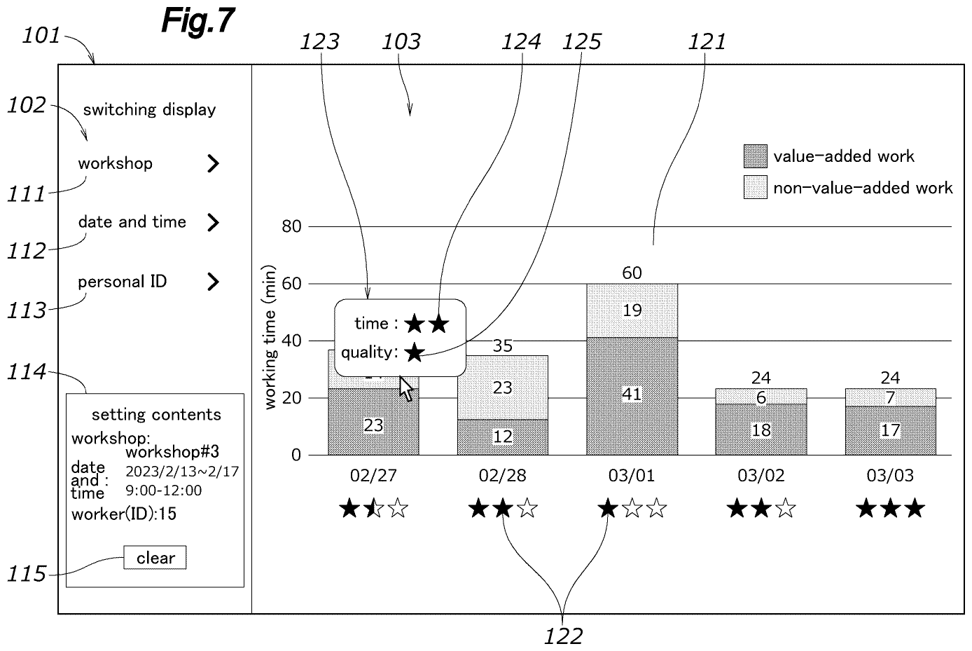

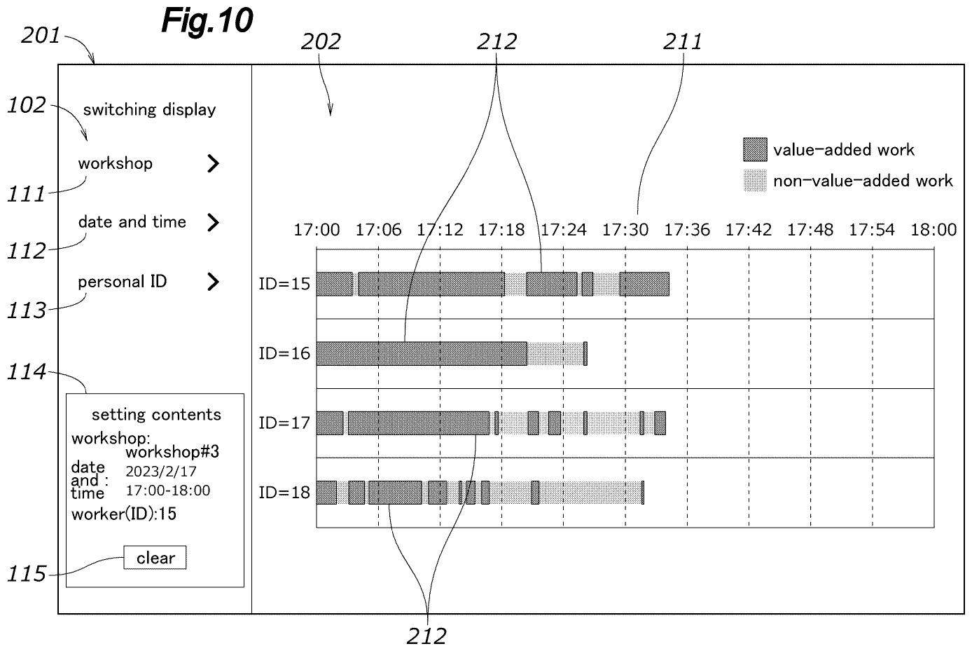

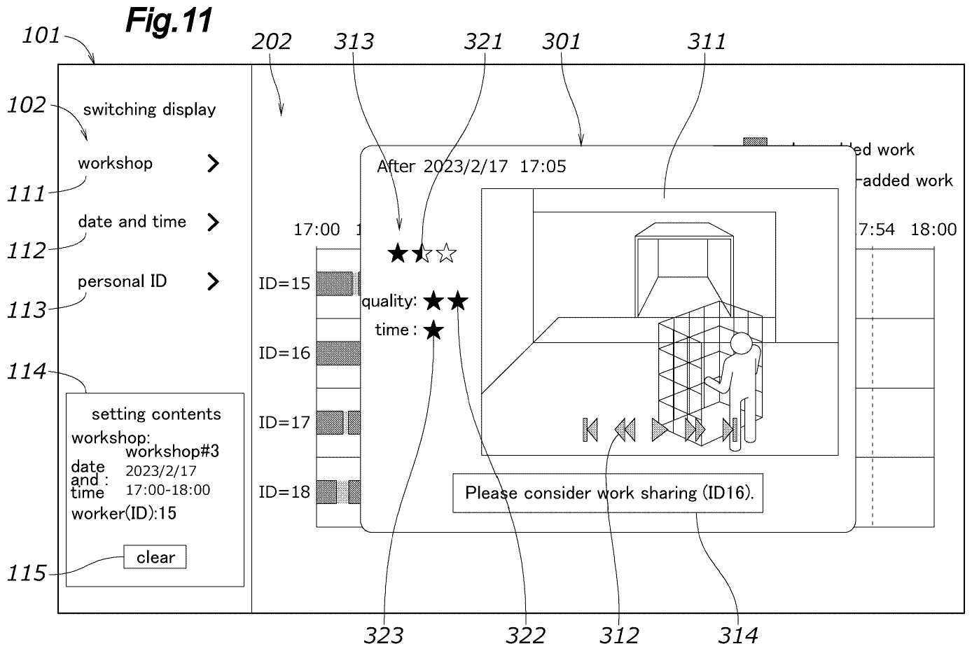

In the display information generation process P7, the processor 33 generates the display information about the screen to be displayed on the user terminal 4. More specifically, the display information about a graph screen 101 (see FIG. 7) including the graph (visualization image) generated in the visualization process P5, a timeline screen 201 (see FIG. 10) including the timeline chart (visualization image) generated in the visualization process P5, and a video playback screen 301 (see FIG. 11) including the proposal contents (messages) selected in the proposal contents selection process P6 and the video from the camera 1 is generated.

Next, the proposal contents selection process P6 executed by the server 3 will be described. FIG. 5 is an explanatory diagram showing the proposal contents (messages) according to the combination of the quality score and the time score.

In the server 3, the contents (messages) to be proposed to the user for the working improvement are selected based on the evaluation results of the working quality and the working time, that is, the quality score and the time score. The message is displayed on the video playback screen 301 (see FIG. 11).

More specifically, in the first case, if the quality score is high and the time score is also high, a message praising the work is displayed. Further, a message proposing an interview for an improvement plan is displayed, that is, a message proposing an interview with another worker to improve the work is displayed. For example, a message saying “Keep it up. Please aim for further overall optimization through work sharing with ID 17. Please also take a break.” is displayed.

In the second case, if the quality score is high and the time score is normal, a message praising the work is displayed. Further, a message proposing an interview for an improvement plan is displayed, that is, a message proposing an interview with another worker to improve the work is displayed. For example, a message saying “Keep it up. If you still have enough time, please consider work sharing with ID 20.” is displayed.

Further, in the third case, if the quality score is high but the time score is low, a message proposing the way to shorten the working time is displayed. For example, a message saying “You are doing the work carefully, so please consider how to shorten the time.” is displayed.

Further, in the fourth case, if the quality score is low but the time score is normal, a message encouraging the user to do the work carefully is displayed. For example, a message saying “You are doing the work within an appropriate time, so please consider how to improve the quality of the work.” is displayed.

Further, in the fifth case, when the quality score is low but the time score is high, a message encouraging the user to do the work carefully in no hurry is displayed. For example, a message saying “You are doing the work within a short time, so please consider how to improve the quality of the work.” is displayed.

Further, in the sixth case, if the quality score is normal and the time score is also normal, a message proposing an improvement plan acquired from a previous interview is displayed. For example, a message saying “There is a working method like XX, please give it a try.” is displayed.

Further, in the seventh case, if the quality score is normal but the time score is low, a message proposing work sharing with a member with a high time score is displayed. For example, a message saying “Please consider work sharing (an example of a worker to share the work: ID16, ID18)” is displayed. The worker with a high time score is extracted based on the time score acquired for each worker in the past.

In the eighth case, if the quality score is low and the time score is also low, a message checking the working state in detail is displayed. For example, a message saying “Let's review how to proceed with the work together.” is displayed.

In the present embodiment, the working time for each worker is acquired, and therefore imbalances in the working time for each worker may be detected by comparing the working time for each worker. In this case, a proposal may be made to the worker or the administrator to share the work between members with high loads and members with low loads.

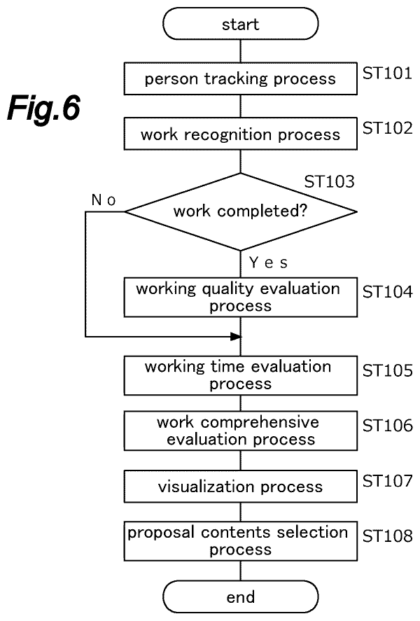

Next, the steps of the process executed by the server 3 will be described. FIG. 6 is a flowchart showing the steps of the process executed by the server 3.

First, the processor 33 tracks the worker doing the work in the workshop based on the video (frame) from the camera 1 (person tracking process P1) (ST101). Next, the processor 33 recognizes the work (the value-added work and the non-value-added work) done by the target worker based on the video from the camera 1 (work recognition process P2) (ST102).

Next, the processor 33 determines whether the work done by the target worker has been completed (ST103). At this time, the completion of the work is detected when a series of actions recognized as one piece of work is performed, and the period in which the value-added work and the non-value-added work have been done is identified.

If the work done by the target worker has been completed (Yes in ST103), the processor 33 then determines the working result, that is, the state of the object as a working target, evaluates the quality of the work done by the worker based on the determination result thereof, and acquires the quality score (working quality evaluation process P12) (ST104).

Next, the processor 33 evaluates the working time of the target worker by comparing the working time of the target worker with the normal time that has been set in advance, and acquires the time score (working time evaluation process P11) (ST105). The working time is calculated by adding the execution time of the value-added work and the execution time of the non-value-added work.

Next, the processor 33 comprehensively evaluates the working state of the target worker based on the time score acquired in the working time evaluation process P11 and the quality score acquired in the working quality evaluation process P12, and acquires the work score (work comprehensive evaluation process P13) (ST106).

Next, the processor 33 generates the information that visualizes the working state of the target worker, that is, the execution states of the value-added work and the non-value-added work (visualization process P5) (ST107). More specifically, a graph 121 (see FIG. 7), a timeline chart 211 (see FIG. 10), and score marks 122, 124, 125, 321, 322, and 323 are generated.

Further, the processor 33 selects the contents (messages) to be proposed to the user for the working improvement based on the evaluation results related to the working quality and the working time, that is, the quality score and the time score (proposal contents selection process P6) (ST108).

On the other hand, if the work done by the target worker has not been completed, that is, if the work is in progress (No in ST103), the working quality evaluation process P12 (ST104) is skipped and the process proceeds to the working time evaluation process P11 (ST105).

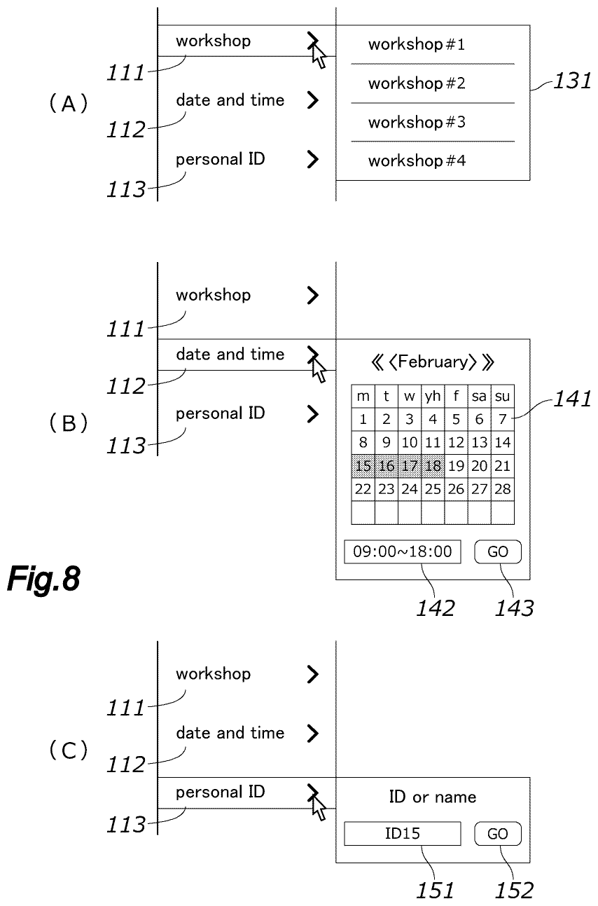

Next, the graph screen 101 displayed on the user terminal 4 will be described. FIG. 7 is an explanatory diagram showing the graph screen 101. FIG. 8 is an explanatory diagram showing a state when a display condition setting section 102 on the graph screen 101 is operated.

The graph screen 101 includes the display condition setting section 102. The display condition setting section 102 includes a workshop designation section 111, a date and time designation section 112, a worker designation section 113, and a setting contents display section 114.

In the workshop designation section 111, the user can identify the workshop to be displayed. As shown in FIG. 8(A), when the user operates the workshop designation section 111, a selection menu 131 is displayed. The selection menu 131 displays a plurality of workshops (for example, workshops #1 to #4). The user can select one of the plurality of workshops in the selection menu 131.

In the date and time designation section 112, the user can identify the date and time to be displayed. As shown in FIG. 8(B), when the user operates the date and time designation section 112, a calendar 141, a time range input section 142, and a “GO” button 143 are displayed. The user can input a date (period) to be displayed in the calendar 141. Further, the user can input the time range to be displayed in the time range input section 142. When the user inputs the date and the time range to be displayed and operates the “GO” button 143, the date and time to be displayed is set based on the input contents.

In the worker designation section 113, the user can identify the worker to be displayed. As shown in FIG. 8(C), when the user operates the worker designation section 113, a worker input section 151 and a “GO” button 152 are displayed. The user can input the ID or name of the worker to be displayed in the worker input section 151. When the user inputs the ID or name of the worker to be displayed and operates the “GO” button 152, the worker to be displayed is set based on the input contents.

As shown in FIG. 7, the setting contents display section 114 displays the setting contents according to the identifying operations of the user in the workshop designation section 111, the date and time designation section 112, and the worker designation section 113. More specifically, the information about the workshop, the date and time, and the worker identified by the user are displayed. Further, the setting contents display section 114 includes a “Clear” button 115. When the user operates the “Clear” button 115, the setting contents are erased.

Further, the graph screen 101 is provided with a graph display section 103. The graph display section 103 displays the graph 121 (visualization image) showing the working time for each day of the target worker. In the graph 121, the execution time of each of the value-added work and the non-value-added work is represented in a stacked graph. This allows the user to understand the working time for both the value-added work and the non-value-added work.

Further, the graph display section 103 displays the score mark 122 (visualization image) that represents the work score for each day. In the score mark 122, the work score is represented by the painted areas of the stars. The identified period (time range) may include plural pieces of work. In this case, the work score for the identified period is calculated by averaging the work scores of the plural pieces of work included in the identified period.

Further, in the graph display section 103, when the user performs a mouse over operation (temporary selection operation) on the display area of each day, a score display box 123 pops up. The score display box 123 displays the score mark 124 that represents the time score and the score mark 125 that represents the quality score. This allows the user to check the time score and the quality score on which the work score is based.

Further, in the graph display section 103, when the user clicks on the display area of each day (actual selection operation), the screen transitions to the timeline screen 201 (see FIG. 10) for the selected day.

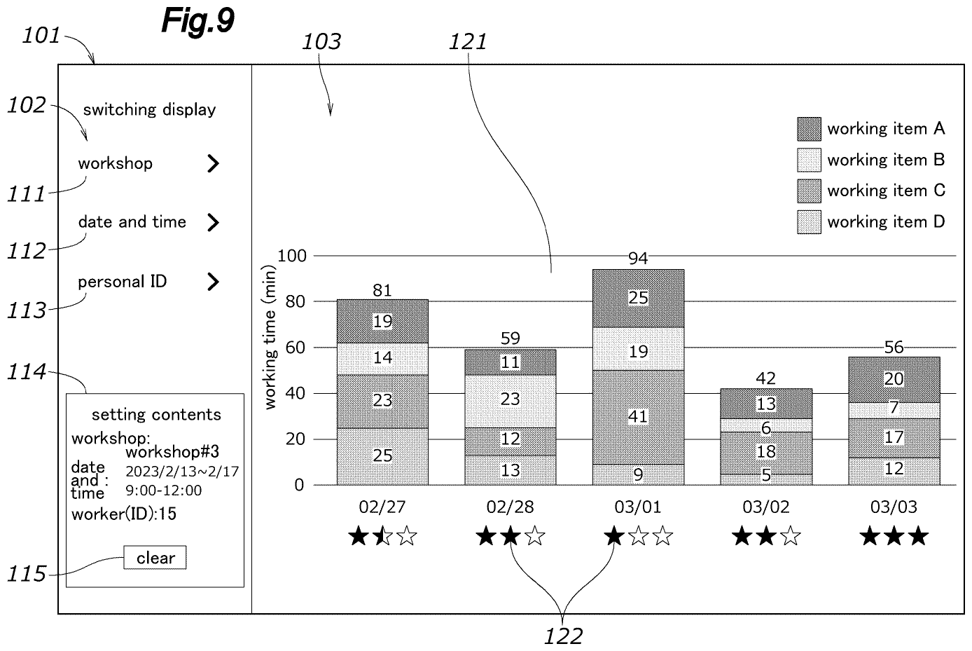

Next, another example of the graph screen 101 will be described. FIG. 9 is an explanatory diagram showing another example of the graph screen 101.

In this example, similar to the example shown in FIG. 7, the graph display section 103 displays the graph 121 (visualization image) showing the working time for each day of the target worker. On the other hand, in the example shown in FIG. 7, the execution time of each of the value-added work and the non-value-added work is represented by a stacked graph in the graph 121. But, in this example, the working time for each working item (A to D) is represented by a stacked graph.

Next, the timeline screen 201 displayed on the user terminal 4 will be described. FIG. 10 is an explanatory diagram showing the timeline screen 201.

The timeline screen 201 includes a timeline display section 202. The timeline display section 202 displays a timeline chart 211. In the timeline chart 211, the horizontal axis represents the time, and the bars 212 that represent the working state of each worker (for example, ID=15 to 19) are displayed to be aligned up and down.

The timeline chart 211 visualizes the execution states of the value-added work and the non-value-added work on a timeline. More specifically, the bars 212 of the timeline chart 211 are drawn in a different form (for example, a different color) for the period of the value-added work and the period of the non-value-added work. This allows the user (work administrator or the worker himself/herself) to check the execution states of the value-added work and the non-value-added work for each worker.

Within the identified time range (for example, 17:00-18:00), during the periods other than the periods in which the value-added work and the non-value-added work are done, the worker stays outside the monitored area (the area captured by the camera 1).

In the timeline display section 202, when the user operates the bar 212 of the timeline chart 211, the video playback screen 301 (see FIG. 11) pops up on the timeline screen 201.

In this example, the timeline chart 211 visualizes the execution states of the value-added work and the non-value-added work on a timeline, but the timeline chart 211 may visualize the execution state of the work for each working item on the timeline.

Next, the video playback screen 301 displayed on the user terminal 4 will be described. FIG. 11 is an explanatory diagram showing the video playback screen 301.

The video playback screen 301 includes a video display section 311. The video display section 311 displays the video captured by the camera 1. The video display section 311 is provided with a playback operation section 312. On the playback operation section, the user can perform an operation related to the playback of the video. This allows the user to check the actual working state in detail. The example shown in FIG. 11 is a case where the worker does the work of loading and unloading the cargo at the truck berth.

On the timeline screen 201 (see FIG. 10), by operating the bar 212 on the timeline chart 211, the period (period from the start time to the end time of the work) for doing the work (the value-added work or the non-value-added work) is specified, and the video for the identified period is played on the video playback screen 301.

Further, the video playback screen 301 includes a score display section 313. The score display section 313 displays a score mark 321 that represents the work score, the score mark 322 that represents the quality score, and the score mark 323 that represents the time score.

Further, the video playback screen 301 includes a message display section 314. The message display section 314 displays a message proposed to the user (the work manager or the worker) for the working improvement. The message is selected based on the evaluation results related to the working quality and the working time, that is, the quality score and the time score (see FIG. 5).

As described above, according to the present embodiment, by selecting the work period on the timeline screen 201 (see FIG. 10), the video for that work period can be played back on the video playback screen 301. Accordingly, for example, the user can focus on the worker with a low work rank on the graph screen 101 (see FIG. 7) and select the focused work period on the timeline screen 201, thereby viewing the video of the focused worker for the focused work period on the video playback screen 301. This allows the user to check in detail the actual working state of the work of the focused worker during the focused work period. Further, the video playback screen 301 displays the message that can be used by the work manager to provide guidance for working improvement and for the self-development of the worker. When playing the video, the working state may be checked using an edited video in which a personal frame of the worker, a traffic flow showing the movement trajectory of the worker, and a mask image to protect the privacy of the worker may be superimposed on the captured video.

As described above, the embodiments have been described as examples of the technique disclosed in the present application. However, the technology in the present disclosure is not limited to this and can also be applied to the embodiments that have been modified, replaced, added, or omitted. It is also possible to combine the components described in the above embodiments to create new embodiments.

### INDUSTRIAL APPLICABILITY

The work analyzing device and the work analyzing method disclosed herein have the effect of enabling a user to examine the working state of the target worker while considering the quality of the work done by the worker, thereby enabling sufficient progress in improving the quality of the work and leveling the work. The work analyzing device and the work analyzing method disclosed herein are useful as a work analyzing device and a work analyzing method that output the analysis information about the working state of the worker based on the video in which the working scene of the worker is captured.

### LIST OF REFERENCE NUMERALS

1: camera
2: recorder
3: server (work analyzing device)
4: user terminal
33: processor
101: graph screen
103: graph display section
121: graph (visualization image)
122: score mark
123: score display box
124, 125: score mark (visualization image)
201: timeline screen
202: timeline display section
211: timeline chart (visualization image)
301: video playback screen
311: video display section
313: score display section
314: message display section
321, 322, 323: score mark (visualization image)

1. A work analyzing device comprising a processor configured to execute a process to output analysis information about a working state of a worker based on a video in which a working scene of the worker is captured,
wherein the processor is configured to:
recognize, based on the video, work done by the worker;
evaluate, based on a working result, working quality of the work done by the worker; and
generate the analysis information that visualizes the working state including an evaluation result of the working quality.

2. The work analyzing device according to claim 1, wherein the processor is further configured to:
recognize, based on the video, value-added work and non-value-added work done by the worker; and
generate the analysis information that distinguishes the value-added work and the non-value-added work.

3. The work analyzing device according to claim 2, wherein the processor is further configured to generate, as the analysis information, a visualization image that represents execution times of the value-added work and the non-value-added work in a stacked manner.

4. The work analyzing device according to claim 2, wherein the processor is further configured to generate, as the analysis information, a visualization image that represents execution states of the value-added work and the non-value-added work on a timeline.

5. The work analyzing device according to claim 1, wherein the processor is further configured to recognize the work done by the worker through action recognition using a plurality of classifiers configured to determine, based on the video, a class to which a recognition target belongs.

6. The work analyzing device according to claim 1, wherein the processor is further configured to select a content of a proposal to a user based on an evaluation result of the working quality and a working time of the worker.

7. A work analyzing method that executes, by a processor, a process to output analysis information about a working state of a worker based on a video in which a working scene of the worker is captured, the work analyzing method comprising:
recognizing, based on the video, work done by the worker;
evaluating, based on a working result, working quality of the work done by the worker; and
generating the analysis information that visualizes the working state including an evaluation result of the working quality.
